(19) United States
(12) Patent Application Publication
(10) Pub. No.: US 2011/0225521 A1
(43) Pub. Date: Sep. 15, 2011

(54) DIGITAL SPHERE LINKED TO ITS BROWSER ACTING AS 3-DIMENSIONAL DESKTOP AND INTERNET BROWSER

(76) Inventor: Turan Cicecki, Dilbeek (BE)

(21) Appl. No.: 13/059,636

(22) PCT Filed: Aug. 24, 2009
(86) PCT No.: PCT/BE2009/000047

§ 371 Date: Jun. 2, 2011

(30) Foreign Application Priority Data
Aug. 22, 2008 (BE) 2008/0463

(51) Int. Cl. G06F 3/01

(52) U.S. Cl. 715/760

(57) ABSTRACT

The present invention relates to a three-dimensional desktop as well as to a browser, allowing more effective and faster browsing and searching on the Internet and computer. The invention is composed of a 3D sphere divided into two equal parts, as well as a 2D browser interconnected and specially designed for the sphere.

The present invention relates to a digital sphere that acts as a 3 dimensional desktop connected to an Internet browser specially designed to be interconnected with the sphere. This invention enables a much faster, more efficient and easier search and navigation on the Internet. It enables, using its architecture, the management and the filtering of the information upstream and downstream and freeing of information by radically changing the configuration of the use of the Internet and of the personal computer.

“Pro Ball” is the code name of the invention, which also designates the sphere.

“Octopus” is the code name of the browser specially designed and linked with the sphere.

### FIELD

The field of the invention is the digital and computing field, more specifically the software field. The field of application of this software is personal computers in particular.

The present invention enables the user to be able to use simultaneously multiple start pages. This technical effect makes possible multiple other effects.

### CURRENT STATE OF THE ART

The Internet became known to the general public during the 1990's and since that time has not considerably changed. Still today, generally speaking the Internet in the broad sense is a browser with one single start page.

The architecture of Pro Ball enables Internet users to be able use Internet with 40 start pages and therefore 40 simultaneous accesses instead of one.

The Pro Ball platform enables distributing and avoiding the domination applied on a single portal by one or multiple search engines.

Therefore, the users will be able to search for information that they need by directly accessing the specific search engine without going through the means of a portal.

### DESCRIPTION

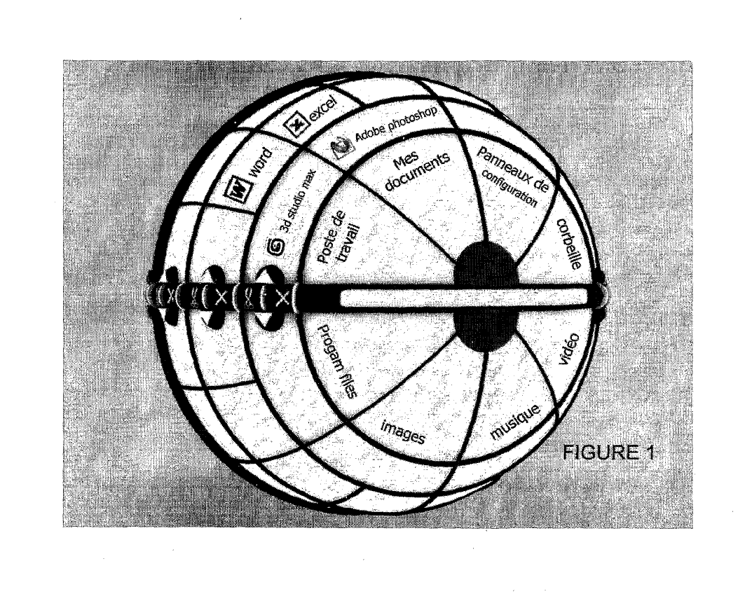

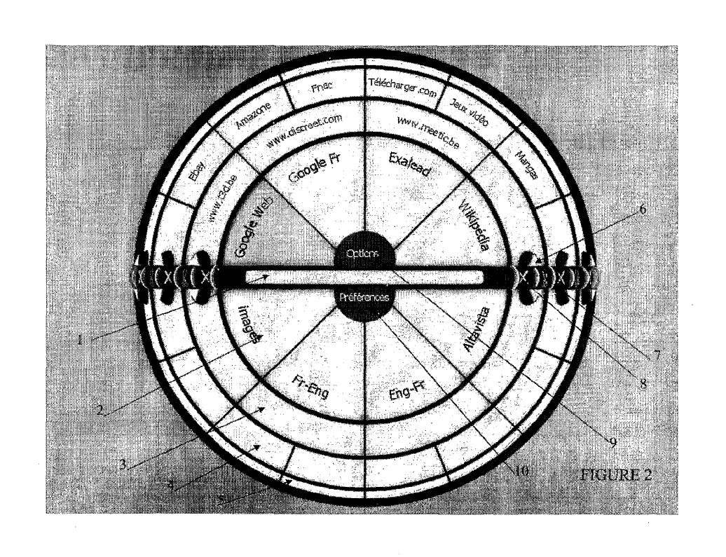

The invention is a digital sphere divided into two equal parts, delimited by a strip (21). The first, the frontal view (FIG. 2), is designed for Internet use,

The second part is designed for the use of the desktop and programs (FIG. 2).

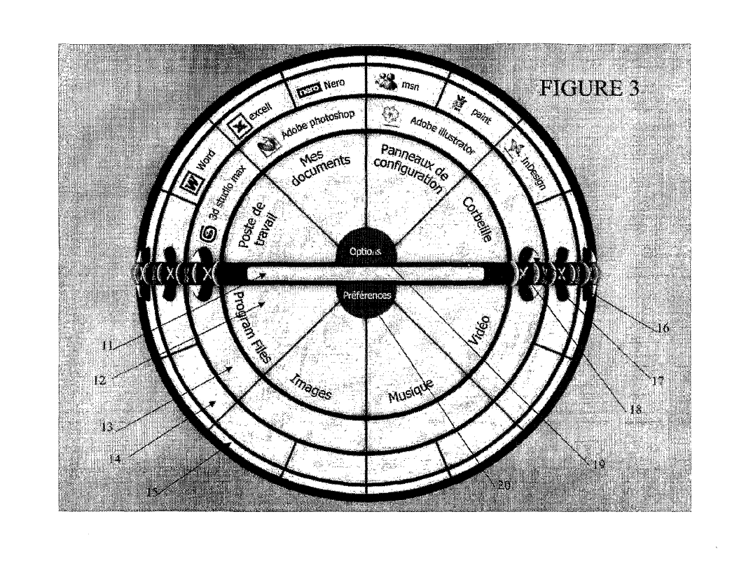

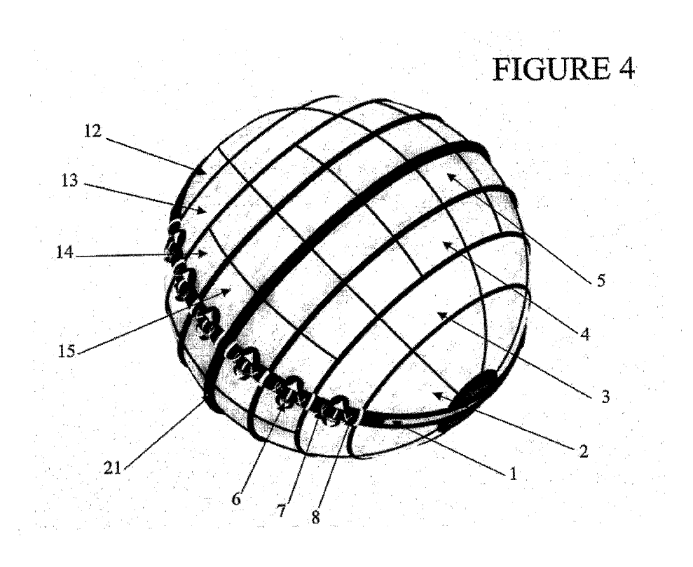

A new type of browser will be connected to this sphere in order to make it more connective, the Octopus browser (FIG. 3).

Appearance and Operations:

The sphere has two parts: that in front and that hidden, delimited by a strip (21). The view or the front face part, FIG. 2, is reserved to the Internet; the other half or the hidden face shown by FIG. 3; is reserved to Internet to the use of the desktop or programs.

To change view, the user will have to rotate the sphere.

The default appearance of pro-ball will be a sphere as shown on the drawings and models attached.

The skin of the sphere can be adapted according to tastes by clicking on a defined function. Similarly, other visual elements can be calibrated (example: the depth, the rotation speed . . . ). Multiple skins (skin) can be loadable in the manner of most tools or software.

A search bar (1) is located in the middle of the first part of the sphere. Another search bar is also located in the back face of the sphere (11).

Segments (2 or 12), enable the user to have a larger use surface

Finally, in each of the views, rings containing the cells or boxes are present (3, 4, 5) or (13, 14, 15)

In Practical Terms:

Pro Ball is a robot that connects to the site and then executes the request. If the user inputs a request into the search bar of pro-ball, the sphere will connect to the specific site and after will use the search module of that site to search and display the result of the initial request.

This algorithm enables elimination of all steps non-essential to the act of search and navigation on the Internet or in a computer.

With Pro Ball, any site having an internal search system becomes a search engine and start pages.

### EXAMPLE OF USE

Here below are concrete examples of use that enable a better understanding as well as a better insight of the utility and speed of this invention.

### Example 1

### Search by a Single Click

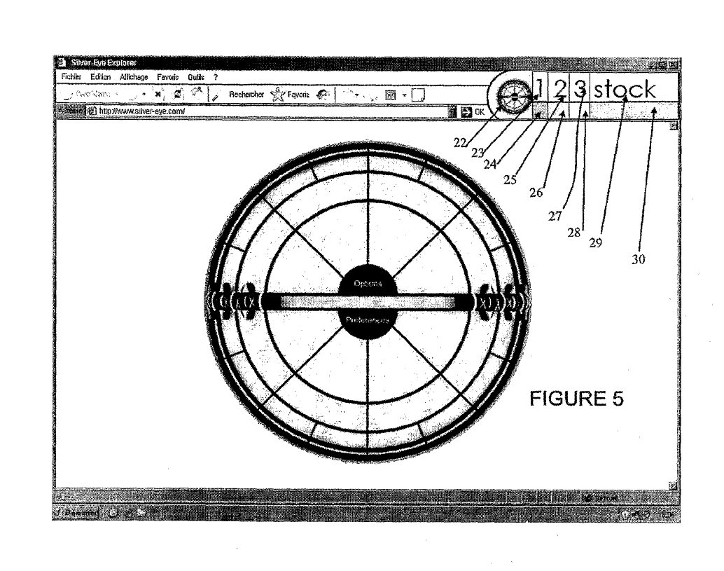

The user who is searching for a vacuum cleaner, on a specific advertising site, will be able to directly search for this vacuum cleaner in the site in question without having to go through another search engine. In this case, the user:
will input the word “vacuum cleaner” into the search bar (number 1)
will click on the link of the advertising site in question, located in the second ring (number 2)
finally will directly obtain the page from the site in question with the list of vacuum cleaners (results). by the means of the browser specially designed for the sphere (FIG. 5)

### Example 2

### Translation a Click Away

With the arborescence system of the information management in the configuration of the current Internet which is a browser, a start page, with a search engine, it is extremely tedious to carry out for example the translation of a sentence into the language of one's choice. This example illustrated below shows the extreme rapidity and ease of the carrying out of this task, provided of course that the task to be carried out be preconfigured.

The user who seeks to translate a sentence:
will input the sentence to be translated into the search bar (1)
will click on the “Eng-FR” link located in the quarters (number 2)
will instantly obtain the result, which will be displayed in the “Octopus” browser

### Example 3

The search bar of the sphere is multifunctional; it is used as well as within the scope of the typical address bar of an Internet browser as the search bar of a search engine.

During the search if the request contains suffixes such as “.com”; “.be”; “.info”, etc, the sphere will then display the exact url or http address by means of the browser. If the request does not contain any suffixes of url recognition (.info; .com; etc.) the sphere will then connect to another preconfigured search engine and, by means of its browser, will display the list of results located according to the key words presented.

Example, if a User Wishes to Access the Site of the Newspaper “lejournal.fr”

In the search bar, the user will input lemonde.fr followed by the key “enter”, will directly access the page of lemonde.fr.

If the user types “lemonde” without the .fr, the sphere will send the user, via the “Octopus” browser, to a search engine page with the display of the results relating to the “lemonde” request.

### Example 4

The sphere will have multiple algorithms that will enable carrying out of custom searches according to the very nature of the link used.

The user inputs “Paris-Brussels” and then clicks on the link of a cartography site. With only one click he will obtain the itinerary and information relating to these two destinations. Via a cartography site, “Pro Ball” will display the itinerary between these two results.

### Example 5

Direct Loading of Configuration and Total Transformation of the Sphere.

A user who wishes to consult newspapers:
will input “newspapers” into the search bar, will then click on options
on load,

All his boxes and links will change into links related to the request; in summary, the links on the sphere will be loaded by links related to newspapers.

### Example 6

Navigation Within the Computer.

After having rotated the sphere, the back view of the sphere is a tool for internal search at the computer. Its operation is identical to that of the system of search via the Internet, FIG. 2

If the user wishes to search for a document under the name wood, by inputting the request wood into the search bar (and or 11), the user obtains the sought document if the request is exact. If the request is not exact to the name of the sought document the sphere will propose a list of documents resembling the request.

The user will be able to effectuate a search according to the nature of the document, if it is a video, image or text processing document for example. By clicking in an image quarter he will have the list of all the documents that are images, then as, as letter entry progresses, the sphere and the search bar will display the different existing documents.

Simplicity of Use:

The appearance of Pro Ball enables a better visibility than other browsers because 3D offers a larger surface of use than 2D, furthermore 3D enables:
the keys and the functions to be of larger sizes
better visibility greatly contributes to the feeling of simplicity.

For an average Internet user, it is very difficult to find one's bearing in the favorites list because it becomes confusing after the addition of about 20 links.

With Pro Ball, there is an increased visibility of favorites, therefore a faster use speed and therefore a time saving.

Moreover, by the location of boxes, Pro Ball enables memorization of links where the different favorites are located.

Commands of the Sphere

This sphere will be able to perform rotations in all the directions. The scroll wheel of a conventional mouse will be configurable in order to make the rotation from left to right or from right to left by offering of course the possibility of a rapid change by pressing the scroll wheel.

In case of a mouse called “Trackball”, the sphere will be able to perform its rotation similarly to the rotation of the ball present in the Trackball mouse.

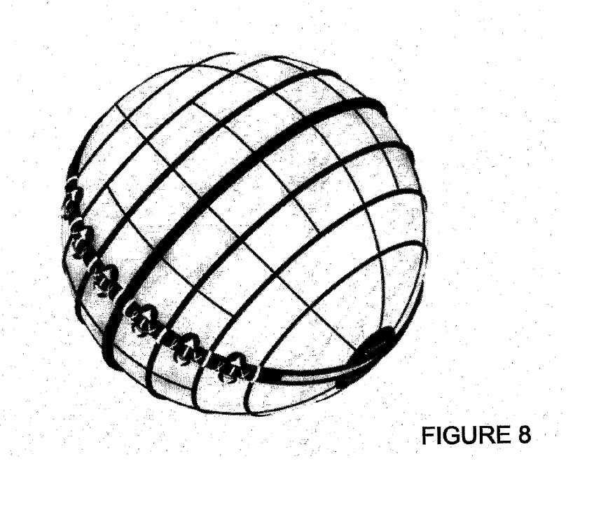

Without necessarily having to use a mouse scroll wheel or any other physical control tool, it is possible to control the sphere by the click of the mouse or by local finger impulsion, according to FIG. 7,

If the user clicks on the field located at the right side of the sphere (31), the sphere will rotate to the right

If the user clicks on the left field (32) the sphere will rotate to the left

Diagonally toward the upper right side (36)

Diagonally toward the lower left side (37)

Diagonally from the lower right side (35)

Diagonally toward the upper left side (38)

Forwards (33), backwards (34)

“Dragging” Effect

When the user will click in a non-textured area of the sphere while maintaining the mouse button pressed and moving this same mouse the rotation of the sphere will be made according to the direction of the mouse.

Different options and variants can be chosen to determine the tools necessary for rotation. These options can be calibrated in the option menu (9 or 19)

Algorithms and Repositioning:

After the user has effected multiple rotations of the sphere the components of this spheres (cells, segments, rings) are located reversed if the user has effected a non-horizontal rotation of the sphere. This reverse rotation of the sphere heavily penalizes the user in terms of ergonomics because the sight of this reversed sphere makes the visibility of the cells difficult and makes it almost impossible to memorize the content of a sphere.

Thus the invention provides for repositioning algorithms.

The horizontal parts of the sphere are divided into 4 parts which are: the Internet navigation part (FIG. 2)

The desktop use part (FIG. 3)

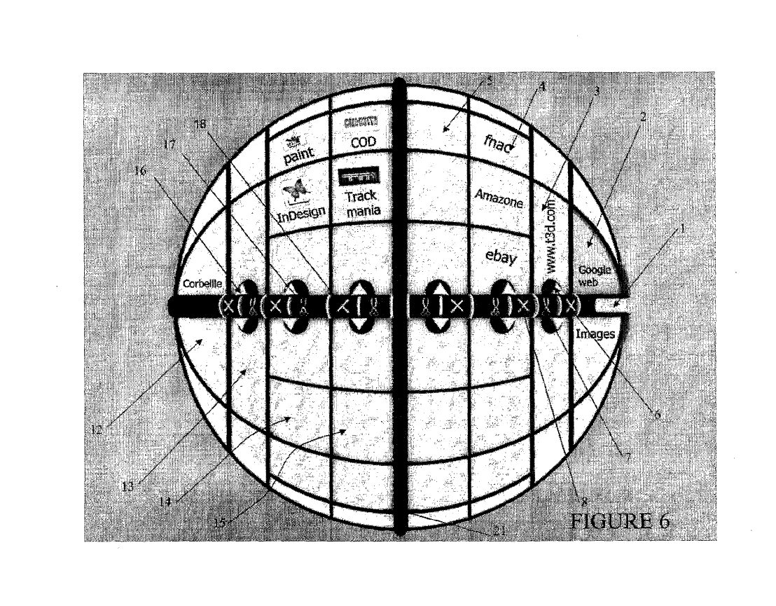

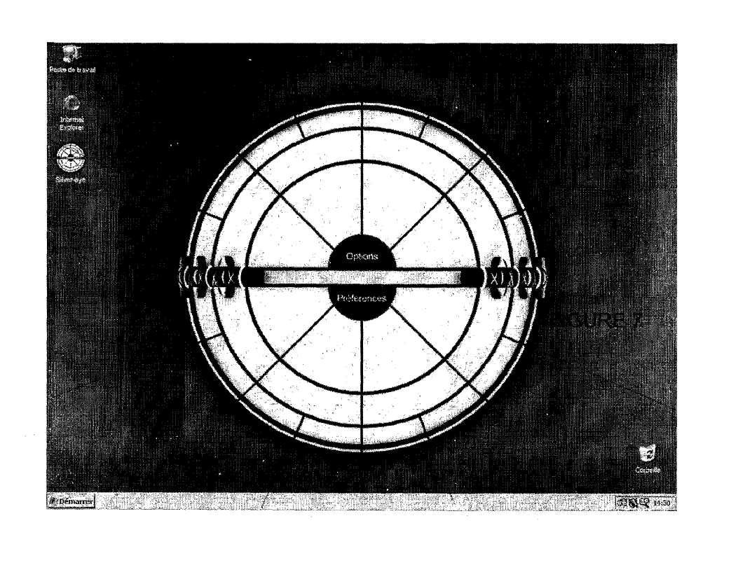

The 90° rotation to the right part (FIG. 6)

The 90° rotation to the left part (FIG. 6)

Dice the user will effect a non-horizontal and non-identical movement to the parts of the sphere by default. The sphere will come back to its horizontal position according to the proximity of the part of the sphere concerned. And this after a predefined period of time that can be one second for example.

If the user effects a “dragging” movement the sphere will come back to a horizontal position after one second. This horizontal position will be the part or the view of the sphere closest to the position of the sphere.

If the user effects non-horizontal rotations the sphere will replace itself to the horizontal.

If the user effects a horizontal rotation but that does not correspond with the parts by defaults of the sphere (FIG. 2, FIG. 3, FIG. 6), the sphere will reposition itself in order to be in view of the sphere by default (FIG. 2, FIG. 3, FIG. 6 and FIG. 6 bis).

Components:

The Search Bar (1):

To effect a search, the user will have to:

1 type his key word

2 click on the preregistered link of a search engine

Number of click: 1

The blue box will be the default search engine of the Internet face. If the user sends his request by the Enter button, it is the link or this search engine (in blue) that will be considered.

It is possible to directly access to a URL address by typing an exact or semi-exact address on this bar. Such as “www.pro-ball.com” or “pro-ball.com”.

In case of inexactness of the URL request, the browser will display the list of URL addresses having neighboring sound or spelling and/or pages of search engine results.

Because the search bar is located in the center of the sphere, we can display the typed in URL addresses at the top of the bar and the previous typed in key words searches at the bottom of the search bar. A conventional browser, due to lack of space, will not be able to display the keyboarding in the top part of its address or search bar.

This search and web address bar will be interactive with its sister, the search bar of the b face of the sphere designed for the use of programs and components of the desktop.

Indeed, when the user issues a request while he is in position 2 (programs face of the sphere) without erasing and by turning only the sphere and clicking on the link of his choice will be able to obtain the expected result. This interactivity operates in the two directions.

The Segments or the Pie Charts (2 or 12):

The most usual sites will be present there such as search engines as well as documentation tools such as translation on-line, encyclopedia or dictionaries sites.

The main quarter will be the site by default, the sphere will consider this site by simply pressing the enter key, if no link has been clicked. Example if the user inputs “car” on the search bar and then the enter key, the sphere will search for the keyword “car” from the site listed in the main quarter. The main segment will have a distinct color. And its choice will be possible by configuring in the options menu

The Rings (3, 4, 5) or (13, 14, 15):

The sphere comprises in its original configuration, for each of its faces, a search bar (1 and 12), 8 segments and 3 rings on which web sites, links, documents or software or any other items will appear.

In the case of the front view designed for the use of Internet, the ring (2) will display sites or web pages still open or in use.

The ring (2) will display, for its part, the favorites previously saved by the user or disseminated in a pre saved configuration.

Using the options section (9 or 19) the user will be able to assign the tasks to the rings, by displaying the favorites in the ring (2 or 12) instead of the pages currently being used, for example.

The third ring (4 or 14) will also display the favorite sites. Because the substrate is a sphere, the third ring is not entirely visible. The user will have to rotate the sphere to be able to use the favorites of ring 3 under optional conditions.

The Arrows

The arrows (6 or 16) enable the user to move at will the boxes of the rings depending on the direction of the arrows; therefore the user will be able initially to chose a specific location for his favorite sites and, afterwards, to have a better overview of these sites in the case of a movement of the sphere. Indeed the third ring of the sphere is not very visible and requires a rotation of the sphere.

According to the direction of the arrows the boxes swap positions, are moved and or are shifted.

The Copy-Paste. Scissors—Glue Jar

The Scissors (7 and 17) enable the user to cut the cell located immediately above the scissors and to then move it to another cell, which can be located in another ring. Once the user clicks on a scissor, all the scissors automatically transform into a “glue jar”, after having chosen the location of the new position of this cell by using the arrow buttons, the user clicks on the “glue jar” and the cell will move to the desired location.

Options (9 or 19):

The options button (9 or 19) enables the users to calibrate, according to their preferences, the various aspects and intrinsic or extrinsic functionalities of the sphere, such as the colors, the appearance of the boxes, the assignment of the rings, the rotation speed, the options for use and all other options necessary for the good use of a program.

Preferences (10 or 20):

The preferences button (10 or 20) enables opening of the configurations for navigation, search or use pre-saved by the user or saved by another typical user of another workstation.

The “X” Buttons (8 or 18):

The box marked with a cross (X) enables the deletion of the link that is located above and below one of these buttons (8 or 18). When the user presses on this button the box above or below it is deleted.

Essence, Fundamental Features of the Invention:

Search:

Pro Ball targets the search fields.

Currently, in order to get a piece of information, it is necessary to go to a search engine and a specific site is lead to. With “Pro Ball” the search is effected directly via targeted sites with a manifest time-saving.

“Pro Ball” is the tool that is going to enable any site having an internal search system to become a search engine with only a single click.

There will not be a single start page and therefore search page but at least 40 start pages. With the hidden part of the sphere 16 of them can be added on, i.e. a total of 48 starting pages (at least). Each favorite site becomes a potential search engine.

Upstream Search Targeting

If a surfer opens a configuration dedicated to music, for example, the sphere will display all sites presaved by the user or not. If the user or another decides to use the website to read his newspapers, he will open the configuration “newspapers”

The user will, if he wishes it, save a configuration or else download an existing configuration over the Internet.

Pro Ball makes it possible to save and therefore to load search configurations or preferences as if it were a Word or Excel document

Consequently the user will have at hand the appropriate links or favorites at the time of a specific search.

Example: if a user wishes to effect a specific search such as a search related to history, he will be able to load a configuration dedicated to history; he will thus have the best tools to effect this search. In the framework of a professional use, this module having the advantage of personalizing and of giving specificities to the computer for each field.

Search and Calibration by Theme:

The users will be able to download pre-saved configurations by theme or category

Downstream Search Targeting

Once the selection operated upstream, whether he has chosen his configuration or not, the user will have a predefined tool to be able to effect what he wishes easily and rapidly.

Currently, it is very difficult to configure a browser: favorites must be added to it. After a time, it becomes difficult to get one's bearings and to find the sought site. With the Octopus browser, there will be 3+1 categories of favorite sites:

The first will enable the user to add the link on the most important site, which is generally the search engine.

The second ring will add the most used favorites; a top 16 program that will add and sort automatically the 16 favorite sites is not excluded.

The 3rd ring (hidden face of the sphere) will repeat the least used favorite sites.

Finally, the last box will enable storage of any interesting link for the user.

B-Face—Desktop Use:

The B-face, the rear face is designed for the use of program and elements of the desktop

After having rotated the sphere to obtain the b-face of the sphere, if the user inputs a request and if that request is exact, then the searched for document will be opened with the default program. If the request is not exact, a window will appear, indicating the various possible spellings, or else announcing the non existence of this document.

The user will be able, if he wishes it, to effect his search according to the type of document sought, if it is for example an image, a video or a word processing document.

An intuitive and spelling filtering system can also be used.

The user has at his disposal search hints corresponding to the type of documents (video, images, documents etc.) In summary, he will search in the category that he will consider most appropriate.

There is therefore a pre-selection of the search of internal documents. Each document dragged on the desktop will be automatically added to the sphere.

Moreover, each file window will have a configuration identical to the Octopus browser. Therefore, the user will be able to reference the programs or files of his choice in the ring of his choice.

Similarly to navigation on the Internet, the b-face device makes the search and use of the desktop and programs much simpler and faster

Loading:

During navigation and searching on the Internet, the user can easily store all types of links on the sphere.

To allow a downstream, and thus also upstream, information arborescence structure, it is necessary that the sphere accomplish a load of any configuration.

In this case, the user will have to click on the preference button, then over open a file. As soon as the file opens the sphere will load in the configuration of the file in question. Example:

“Octopus” Browser

To display internet pages, a browser is necessary, FIG. 5.

The “Octopus” browser has the special feature of combining the same targeted search functionalities as the browser part of the sphere.

Boxes 1-2-3 Corresponding to the Rings of the Sphere.

If the user presses on one of these numbers, the current page will be added into the ring of the sphere and into the browser directory.

The more sphere will not include rings or segments, the more the browser will include numbers or sections corresponding to the sections located on the sphere.

The numbers add the special feature of sorting favorites by order of importance.

The category or box 1 segments of the sphere (23 or 24: will be dedicated to the most common search engines.

Category 2 (25 or 26): will be dedicated to the set of the most used favorite sites

Category 3, non-visible rings of the sphere (27 or 28): will be the set of the least used favorite sites.

And the storage category (29 or 30) will enable storage of an undefined quantity of favorite sites.

If the user clicks on one of the arrows shown below a number, the list of favorites corresponding to the number will appear. Therefore the user will be able to either choose his favorite or use it to effect a targeted search.

In summary, with a single click, the user will be able to add, into the sphere and into his browser, the favorite of his choice. Given that the configuration of the sphere is preset to remove favorites with the <<X>> keys, the browser balances the removal with easy addition of favorites.

For an entity to be a dynamic and lively, its components must be easily removed and added.

Use of the Browser by Tab and Rings:

According to FIG. 5, when the user will press on the sphere icon (22), the sphere will come back to the foreground ready to be used.

During the visit to a web page, if the user presses on box 1 (23), the current site will automatically be added to the segments of the sphere (2). If the user prefers to click on box 2 (25), then the current site will be installed in the second ring of the sphere; if he presses on box 3 (27), the site will be added to ring 3 of the sphere (3), and if finally the user presses on the storage box (29), the site will be referenced in a file designed to store the favorite sites.

If the user presses on one of the boxes located below the numbered boxes, then a menu will open listing the elements present on the sphere respectively with locations indicated by the numbers. If for example the user clicks on the box (24) located below box 1 (23), then a menu will open reporting of the list of the sites or links present in the part designed with the segments.

Using this menu, the user will be able to effect a search by inputting his request on the search bar of his browser, and will then click on a link located in a menu, and will then obtain the result of his request directly on the chosen site.

The design of this invention is a sphere chosen for its optimal features for this type of programs. It will be the form by default of this invention.

### CONCLUSION

Dice then various possible forms having the same intrinsic features of the sphere can be imagined.

All forms are possible and imaginable as long as they fulfill the features of the sphere.

This invention enables navigation by favorite and a targeted search. Any site having an internal search system can be referenced in the sphere to become a navigation tab. The search becomes more targeted and above all faster because the non-essential navigation processes are eliminated.

The complementarity between the sphere and its brother, the Octopus browser, add to the modularity of the assembly; it is as easy to remove links on the sphere as it is easy to add some to the browser.

The categorization of the favorites will make navigation and searching much more orderly.

The everyday acceptance of touch screens and mobile internet for GSM will be appropriate industrial supports for Pro Ball.

1. System of navigation, information arborescence, and use of a computer, characterized in that it comprises:
A digital and/or physical sphere interconnected with an Internet browser specially designed for this sphere.

2. System of navigation, information arborescence, and use of a computer according to claim 1, characterized in that:
The sphere has two separate parts, the first for use of the Internet and the second for the use of programs and documents internal to the computer.

3. System of navigation, information arborescence, and use of a computer according to claim 1, characterized in that it comprises:
A search tool in the form of a search bar that can be either an address bar of a browser or a conventional search bar and that interacts with different elements, parts, assemblies and subassemblies present on the surface of the sphere.

4. System of navigation, information arborescence, and use of a computer, characterized according to claim 1 in that:
The sphere has assemblies and subassemblies comprising cells or box that are segments, cell rings and any other geometrical shapes that can contain a group or subgroup of cells, segments and/or boxes.

5. System of navigation, information arborescence, and use of a computer, according to claim 1, characterized in that it comprises:
Directional devices that enable the user to move within a same group or subgroup, the boxes, the cells or any other desired item.
A copy-paste process enabling cutting of the desired box or cell to then paste them using the same button that will transform into a glue jar after the impulsion of the aforementioned system.

6. System of navigation, information arborescence, and use of a computer, according to claim 1, characterized in that it comprises:
Devices for deletion of cells or boxes that enable the user to delete a box or a cell with one or multiple clicks.

7. System of navigation, information arborescence, and use of a computer according to claim 1, characterized in that:
The search bar displays the browser keyboarding at the top or bottom of the aforementioned bar and displays the search keyboarding in an area opposite to that of the browser keyboarding.

8. System of navigation, information arborescence, and use of a computer according to claim 1, characterized in that:
The sphere effectuates its rotations in all directions using a physical command such as the use scroll wheel of a mouse for example and also using the digital commands via mouse pointer clicks or localised digital impulsions.

9. System of navigation, information arborescence, and use of a computer according to claim 1, characterized in that it comprises:
Interaction and connectivity devices enabling the browser to have the same modules, menus, assemblies and subassemblies enabling an interaction between the sphere and the browser, devices, These devices correspond totally, content, function of each of the assemblies and subassemblies present on the sphere. After having clicked on one of these devices, the user will be able to see and use the cell or the box of one of the assemblies or subassemblies of the sphere (segments, rings or other).

10. System of navigation, information arborescence, and use of a computer according to claim 1, characterized in that it comprises:
An interaction process present on the browser, so that the site, document or any item currently being visualized, can be added to the sphere by a single one click or more to the desired area on the sphere being given that the systems respectively correspond to the assemblies and subassemblies of the sphere.

11. System of navigation, information arborescence, and use of a computer, according to claim 1, characterized in that it comprises:
A system allowing to go back to the sphere, this system allows the user to go back to the sphere or to make it reappear.

12. System of navigation, information arborescence, and use of a computer according to claim 1, characterized in that:
The user will be able to save a search, navigation or user database in order to be able to open it later, he will also be able to send and share this database with other users.

13. System of navigation, information arborescence, and use of a computer, according to claim 1, characterized in that it comprises:
des repositioning algorithms; after a certain predefined period of time the sphere repositions itself horizontally according to the 4 views of this same sphere.

14. System of navigation, information arborescence, and use of a computer according to claim 1, characterized in that: the appearance of the sphere, the background color of the cells and segments, the grids and the text can be modified and saved according to the will of the users via a configuration menu.
